(19) United States
(12) Patent Application Publication
(10) Pub. No.: US 2010/0021609 A1
(43) Pub. Date: Jan. 28, 2010

(54) Snack food product and method

(76) Inventors: Peter H. Mattson, Hillsborough, CA (US); Scott Loh, Pacifica, CA (US); Michael Bockman, Visalia, CA (US)

Correspondence Address: Thomas M. Freiburger, P.O. Box 1026, Tuburon, CA, 94920, US

(21) Appl. No.: 12/220,311

(22) Filed: Jul. 22, 2008

(51) Int. Cl. A21D 8/02

(52) U.S. Cl. 426/549

(57) ABSTRACT

A crunchy, somewhat nutty baked snack food product is formed with sunflower seeds. The product, preferably in the form of small bits less than one inch in size, contains whole grains and has a nut bite texture. In a preferred form the sunflower seeds in the snack bits are exposed at the outer surface for a visual and texture appeal.

### BACKGROUND OF THE INVENTION

This invention concerns snack foods, and in particular a snack food based on sunflower seeds formed in small baked bits and with a nut-like texture when consumed.

Sunflower seeds are a popular and healthful snack. An object of this invention is to produce a snack based on sunflower seeds but with the general texture and general size of nuts, and with a nutty and crunchy bite feel, good fiber content and the flavor of sunflower seeds, but with 25% to 40% less fat than nuts.

### SUMMARY OF THE INVENTION

Pursuant to the invention a crunchy, baked snack food is produced by steps of mixing and blending ingredients, extruding dough and cutting small coin-shaped pieces, baking, cooling, glazing, applying seasoning and drying the snack bites. The formula for the snacks includes sunflower seeds, flour, water, sugar and salt, and preferably also sunflower, canola or safflower oil, inulin, gluten and sesame seeds.

The dry ingredients are mixed together, and the wet ingredients preferably are mixed separately, the latter comprising water and oil, preferably sunflower oil. The wet and dry ingredients are fed, preferably on a continuous basis, into a dough blender, and the blended dough moves from the dough blender into a hopper for extrusion, preferably a gravity fed hopper.

Extrusion is made through a small die which may be about ½ to ¾ inch in diameter (or even as small as about ¼ inch in diameter), and the extruded stream is cut into small coin-like shapes immediately as it extrudes from the hopper. The cut, coin-shape dough pieces are fed onto a conveyor belt, and on this belt they preferably are submerged in caustic soda as a surface treatment, and salt can also be applied here, preferably sea salt.

Next, the dough pieces are baked. In a preferred procedure this bake is conducted in a two-step bake process, with a high temperature bake (about 500° F., about five minutes) first, then a lower-temperature bake which dries the pieces down to about 2% moisture content. The second bake/glaze/drying step can be at about 280° for about ten minutes.

Following baking, the pieces are transferred to a cooling conveyor, cooled and then seasonings are applied. This may be done by first spraying a starch solution onto the baked pieces, then applying topical seasoning in a drum. Finally, the baked, seasoned snack pieces are dried at about 250° F. for about five minutes, then packaged.

The resulting snack food product is in the form of small, bite-sized, browned, crunchy pieces having a heavy texture due to the density of the sunflower seeds and the presence of the seeds at the exterior of the snack piece, with high fiber and a pleasant sunflower seed taste, preferably also with a secondary flavor of sesame seeds.

It is therefore among the objects of the invention to produce a healthful, high-fiber snack food in the form of crunchy pieces with a somewhat nutty sunflower flavor, with a process generally as described above. These and other objects, advantages and features of the invention will be apparent from the following description of a preferred embodiment, considered along with the accompanying drawings.

### DESCRIPTION OF THE DRAWINGS

FIG. 1 is a flow chart schematically indicating the process of the invention for producing a snack food.

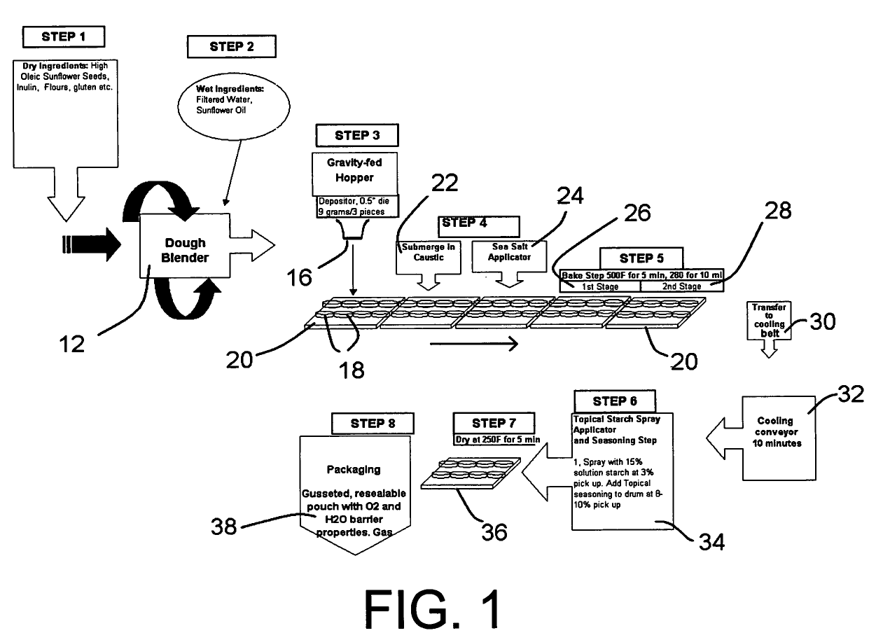

FIGS. 2 and 3 are perspective views generally indicating the appearance of finished snack food pieces of the invention.

### DESCRIPTION OF PREFERRED EMBODIMENTS

The drawing shows, in a schematic flow chart or block diagram representation, a process for producing sunflower seed snack food items as described above. The product is crunchy and is healthful by virtue of its inclusion of sunflower seeds and sesame seeds and through high fiber provided primarily from inulin in the baked snack pieces, although other suitable sources of fiber can be used.

Steps 1 and 2 of the drawing indicate that dry ingredients are mixed separately from wet ingredients. The dry ingredients preferably include high oleic sunflower seeds, inulin, flour and gluten and may also include sugar, salt and sesame seeds. Several different types of flour can be included, including a high-protein flour and a whole wheat flour. The salt is preferably sea salt.

The wet ingredients include water (preferably filtered water) and an oil, sunflower oil being preferred. These ingredients are mixed together in a dough blender 12, preferably on a continuous basis. The resulting dough is fed into a hopper 14 as shown in step 3, and this may be a gravity-fed hopper. From the hopper the dough is extruded through an extruding die 16, where the dough extrusion is immediately cut into coin-shaped or disc-shaped pieces 18 as the extrusion emerges from the die 16. In one preferred form of the process and invention, the die is about ½ inch in diameter, and each piece sliced from the extrusion weighs roughly about three grams. More broadly the die can be in the range of about ¼ inch to ⅝ inch or ¾ inch diameter, and the cut pieces can have a weight in the range of about 2 to 8 grams. The extruding die, shown schematically at 16 in the drawing, can actually comprise several dies operating in parallel so as to deposit the disc-shaped cut dough pieces 18 row by row onto a conveyor 20 as indicated in the drawing.

The diagram shows in step 4 that the cut dough pieces preferably are submerged in caustic soda at 22, a known step in baking of snacks to form a desired crust. A caustic “glaze” is applied, containing salt as indicated at 24, preferably sea salt. If desired all salt can be applied at this step, without inclusion of salt at step 1.

At step 5 is indicated two separate baking steps, a first stage 26 and a second stage 28. The second stage can be considered a drying step, being a low-temperature bake, and dries the glaze applied at step 4. In one preferred implementation the first stage 26 is a 500° F. bake for about five minutes, with the second stage at about 280° F. for about ten minutes. Following the second stage 28, the product preferably is dried to the extent of about 2% moisture content.

The step 30 indicates transfer from the belt 20 to a cooling belt, then cooling of the product on this conveyor belt for about ten minutes as noted at 32.

Next, the baked pieces are seasoned at step 6. As indicated in the block 34, a topical starch may be sprayed onto the dough pieces, both sides in a drum, to promote adhering of topical seasonings onto the baked pieces. The spray solution can be, for example, about a 15% starch solution at 3% pickup. In the drum the dry topical seasoning is added, at about 8% to 10% pickup.

In step 7 the baked, seasoned pieces are dried on the conveyor 36, and this can be, for example, at about 250° F. for five minutes.

Step 8 indicates packaging, in the block 38. The baked, cooled, seasoned and dried snack pieces preferably are packaged in a gusseted, re-sealable pouch with oxygen and water barrier properties. A gas flush (preferably nitrogen) can be used to assure freshness.

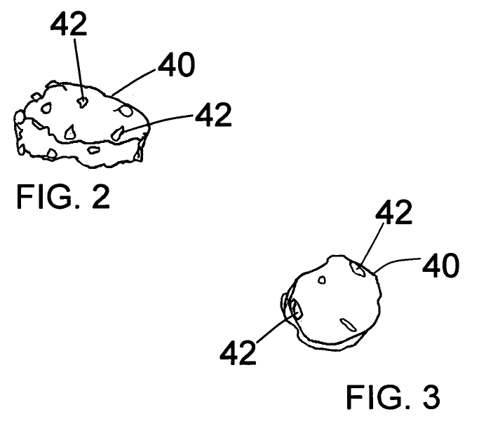

FIGS. 2 and 3 show approximately the appearance of the baked sunflower seed snacks 40 produced by the invention. The baked pieces 40 are browned and have a somewhat pretzel-like skin texture, and are irregular in shape, particularly because of sunflower seeds 42 which emerge to the surface and extend partially outwardly in the finished product. The snack pieces are typically somewhat round in shape and preferably are up to about one inch in maximum dimension with an average diameter or width of approximately ½ inch to ⅞ inch. The snack pieces typically and preferably have a thickness of about ⅜ inch to ½ inch maximum, with the maximum typically occurring close to the center. The rough exterior appearance of the snack morsels tends to compliment the crunchy texture. It should be understood that the dimensions can vary; the average diameter can be up to about 1½ inch, and the thickness can be in a range of about ¼ inch to ¾ inch. The shape can be somewhat different, with a smaller extruded diameter and a greater length, producing snack pieces more cylindrical.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

We claim:

1. A method for producing a snack food containing sunflower seeds, comprising:
combining dry ingredients including sunflower seeds and flour with wet ingredients including water and oil, in a dough blender to form a dough,
feeding the dough from the dough blender and forming a narrow stream of the dough, and cutting the dough from the narrow stream into pieces,
depositing the cut dough pieces onto a baking conveyor,
conveying the dough pieces through a baking oven to bake the dough pieces, forming baked pieces,
cooling the baked pieces,
applying seasoning topically to the baked pieces, drying and then packaging the seasoned baked pieces.

2. The method of claim 1, wherein the dry ingredients further include sugar and sea salt.

3. The method of claim 1, wherein the dry ingredients include inulin.

4. The method of claim 1, wherein the dry ingredients include gluten.

5. The method of claim 1, wherein the oil is sunflower oil.

6. The method of claim 1, wherein the sunflower seeds comprise high oleic sunflower seeds.

7. The method of claim 1, further including the step of submerging the dough pieces in caustic soda before baking.

8. The method of claim 1, further including the step of applying salt to the dough pieces before baking.

9. The method of claim 1, wherein the dough pieces are cut to about three grams weight each.

10. The method of claim 1, wherein the baking of the dough pieces comprises a first bake stage at about 500° F. for about five minutes, and a second bake and drying stage at about 280° F. for about ten minutes.

11. The method of claim 1, further including spraying starch onto the baked pieces as an adherent prior to applying seasoning.

12. The method of claim 11, wherein the starch is sprayed with approximately 15% starch solution at 3% pickup, and wherein the topical seasoning is applied in a drum, adhered to the baked pieces by the starch solution at about 8% to 10% pickup.

13. The method of claim 1, wherein the cooled and dried baked pieces are packaged in a gusseted, re-sealable pouch with oxygen and water barrier properties.

14. The method of claim 1, wherein the step of feeding the dough from the dough blender is performed on a continuous basis.

15. The method of claim 1, wherein the dry ingredients further include sesame seeds.

16. The method of claim 1, wherein the dough from the dough blender is passed through an extruding die to form the narrow stream as a continuous dough extrusion which is cut to form generally disc-shaped dough pieces.

17. The method of claim 16, wherein the extruding die has a diameter of about ½ inch.

18. The method of claim 16, wherein the extruding die has a diameter of about ¼ inch to about ¾ inch.

19. The method of claim 16, wherein the extrusion is cut into pieces about ⅛ inch in length.

20. The method of claim 1, wherein the seasoned, baked pieces have an average width or diameter of about ½ inch to ⅞ inch and a thickness at maximum of about ⅜ inch to ½ inch.

21. Baked snack food pieces formed according to the method of claim 1.
